(19) United States
(12) Patent Application Publication
(10) Pub. No.: US 2009/0210798 A1
(43) Pub. Date: Aug. 20, 2009

(54) MEDIA PRESENTATION FOR USE WITH IMPLANTABLE DEVICE

(75) Inventors: Gang Wu, San Clemente, CA (US); Hai Huang, Woodbury, MN (US); James Kalgren, Lino Lakes, MN (US)

Correspondence Address: SCHWEGMAN, LUNDBERG & WOESSNER/BSC-CRM, PO BOX 2938, MINNEAPOLIS, MN, 55402, US

(73) Assignee: Cardiac Pacemakers, Inc., st paul, MN (US)

(21) Appl. No.: 12/370,419

(22) Filed: Feb. 12, 2009

Related U.S. Application Data
(60) Provisional application No. 61/029,711, filed on Feb. 19, 2008.

(51) Int. Cl. G06F 3/048

(52) U.S. Cl. 715/730

(57) ABSTRACT

This document discusses, among other things, a system and method for determining a media presentation to present to a user using at least one of information received from an implantable medical device or information received from the user.

### CROSS-REFERENCE TO RELATED APPLICATION

This application claims the benefit of U.S. Provisional Application No. 61/029,711, filed on Feb. 19, 2008, under 35 U.S.C. §119(e), which is hereby incorporated by reference.

### BACKGROUND

Certain implantable medical devices, such as various pacemakers or defibrillators, have parameters such as settings or features that can be specifically tailored for an individual patient. A user can tailor, set, or otherwise change these parameters by communicating with the implantable medical device using a user-interface, such as a medical device programmer. The user-interface can be configured to provide information to a user.

### OVERVIEW

This document discusses, among other things, a system and method for determining a media presentation to present to a user using at least one of information received from an implantable medical device or information received from the user.

In Example 1, a system includes a user-interface configured to be communicatively coupled to an implantable medical device, the user-interface configured to determine a multimedia presentation to present to a user, wherein the user-interface is configured to determine the multimedia presentation by selecting at least one multimedia presentation from a plurality of stored multimedia presentations using at least one of information received from the implantable medical device or information received from the user, wherein the user-interface is configured to determine the multimedia presentation without requiring the user to directly determine the multimedia presentation.

In Example 2, the user-interface of Example 1 is optionally configured to determine the multimedia presentation to present to at least one of a patient, an electrophysiologist, a cardiologist, a physician, or a nurse.

In Example 3, the user-interface of any one or more of Examples 1-2 optionally includes a display, wherein the user-interface of any one or more of Examples 1-2 optionally is configured to present the selected at least one multimedia presentation to the user to select to view using the display.

In Example 4, the user-interface of any one or more of Examples 1-3 optionally is configured to determine the multimedia presentation to present to the user using information received from the implantable medical device.

In Example 5, the user-interface of any one or more of Examples 1-4 is optionally configured to determine the multimedia presentation using information received about the implantable medical device.

In Example 6, the user-interface of any one or more of Examples 1-5 is optionally configured to receive information about an activated feature of the implantable medical device for a patient, to determine the multimedia presentation using the information about the activated feature, and to present the multimedia presentation to that patient, the multimedia presentation including information about the activated feature.

In Example 7, the user-interface of any one or more of Examples 1-6 is optionally configured to determine the multimedia presentation using information received about a patient.

In Example 8, the user-interface of any one or more of Examples 1-7 is optionally configured to receive patient information, to determine the multimedia presentation using the patient information, and to present the multimedia presentation to that patient including information about the patient information.

In Example 9, the user-interface of any one or more of Examples 1-8 is optionally configured to determine the multimedia presentation to present to the user using information received from the user.

In Example 10, the user-interface of any one or more of Examples 1-9 is optionally configured to determine the multimedia presentation using information about a user class, the user class including at least one of a patient class, an electrophysiologist class, a cardiologist class, a physician class, or a nurse class.

In Example 11, the user-interface of any one or more of Examples 1-10 is optionally configured to determine the multimedia presentation using information about the implantable medical device, the information about the implantable medical device of optionally including information about at least one of an implantable medical device type or an implantable medical device family.

In Example 12, the user-interface of any one or more of Examples 1-11 is optionally configured to determine the multimedia presentation using information about a patient, the information about the patient optionally including information about at least one of a physiological condition or a patient history.

In Example 13, a method includes providing a user-interface for a user, the user-interface configured to be communicatively coupled to an implantable medical device, receiving, at the user-interface, at least one of information from the implantable medical device or information from the user, and determining, at the user-interface, a multimedia presentation to present to the user by selecting at least one multimedia presentation from a plurality of stored multimedia presentations using the received information, the determining without requiring the user to directly determine the multimedia presentation.

In Example 14, the method of Example 13 optionally includes presenting the selected at least one multimedia presentation to the user to select to view.

In Example 15, the method of any one or more of Examples 13-14 optionally includes receiving, at the user-interface, information from the implantable medical device, wherein the determining the multimedia presentation to present to the user of any one or more of Examples 13-16 optionally includes using the implantable medical device information.

In Example 16, the receiving the information from the implantable medical device of any one or more of Examples 13-15 optionally includes receiving information about an activated feature of the implantable medical in a patient, and wherein the determining the multimedia presentation of any one or more of Examples 13-15 optionally includes using the activated feature information.

In Example 17, the method of any one or more of Examples 13-16 optionally includes detecting physiological information from a patient using the implantable medical device, wherein the receiving the information from the implantable medical device of any one or more of Examples 13-16 optionally includes receiving the detected physiological information, and wherein the determining the multimedia presentation of any one or more of Examples 13-16 optionally includes using the detected physiological information.

In Example 18, the method of any one or more of Examples 13-17 optionally including receiving information from the user, wherein the determining the multimedia presentation to present to the user of any one or more of Examples 13-17 optionally includes using the user information.

In Example 19, the receiving the information from the user of any one or more of Examples 13-18 optionally includes receiving at least one of a user class, information about the implantable medical device, or information about a patient.

In Example 20, a system includes a user-interface, communicatively coupled to an implantable medical device, the user-interface configured to receive information about an activated feature of the implantable medical device for a patient, to select at least one multimedia presentation to present to the patient from a plurality of available multimedia presentations using the information about the activated feature, and to present the at least one selected multimedia presentation to the patient, wherein the at least one selected multimedia presentation includes information about the activated feature without requiring information about a non-activated feature, and wherein the user-interface is configured to determine the multimedia presentation without requiring the user to directly determine the multimedia presentation.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of a system including a user-interface.

FIG. 2 illustrates generally an example of a system including a user-interface and an implantable medical device (IMD).

FIG. 3 illustrates generally an example of a system including a user-interface, an implantable medical device, a local programmer, and a remote programmer.

FIGS. 4-6 illustrate generally an example of a method including determining a media presentation to present to a user.

### DETAILED DESCRIPTION

The present inventors have recognized, among other things, that it can be advantageous to enhance a user-interface, such as a medical device programmer, with an interactive media presentation (e.g., audio or video) to enhance a user experience. In various examples, by providing interactive media to the user, or media that depends at least in part upon information received from an implantable medical device or from the user, training or other information sessions can be targeted to the individual user, or to a particular class of user. For example, using the received information, the training or information session can be tailored to fit the education, experience, or expectation of the user. In certain examples, the duration of the session can be shortened, such as by eliminating information that would likely already be known to particular individual users or to certain classes of users, or by eliminating information not pertinent to the user (e.g., eliminating information about one or more features that are not in-use). In other examples, using received information from the user, the session can be tailored to provide certain information (e.g., information interesting or confusing to the particular user) with more specificity or more in-depth than other information (e.g., information known or not interesting to the particular user).

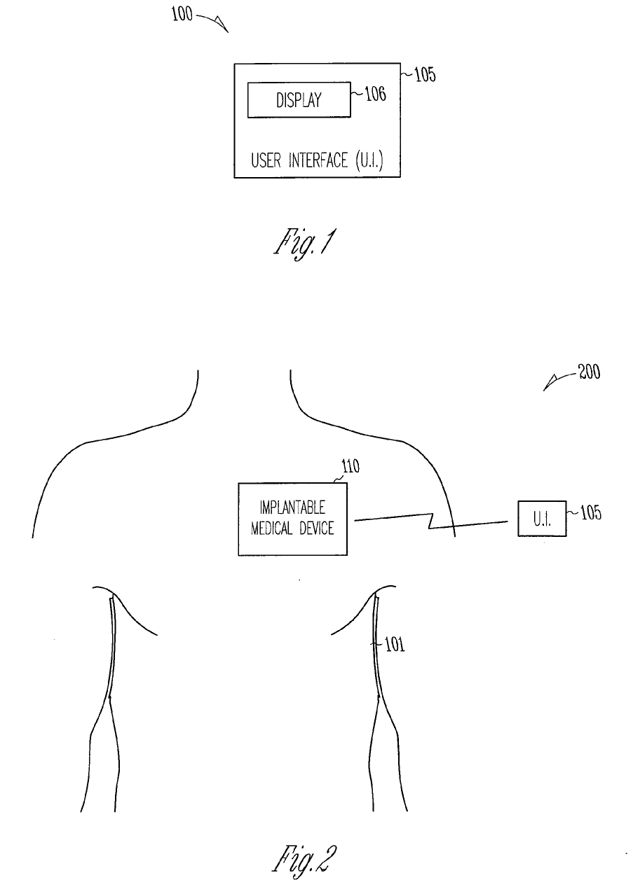

FIG. 1 illustrates generally an example of a system 100 including a user-interface (u-i) 105 having a display 106. In this example, the user-interface 105 can include a device configured to provide interaction between a user and an implantable medical device (IMD). In an example, the user-interface 105 can be configured to determine a media presentation (e.g., audio or video) to present to the user. In various examples, the user-interface can include one or more of a medical device programmer, a repeater, a computer, a personal digital assistant (PDA) or other device having digital or analog circuitry, communication circuitry, and a display configured to display information, such as media, including audio or video, to the user. In an example, the user-interface 105 can include a physician-operated user-interface configured to display information to or receive information from a physician. In other examples, the user-interface 105 can include a patient-operated user-interface configured to display information to or receive information from a patient or other user. In an example, the patient-operated user-interface can have a more limited set of commands or capabilities than a physician-operated user-interface.

In an example, the user-interface 105 can be configured to display information (e.g., the media presentation) to a user using the display 106. In an example, the display 106 can include a liquid crystal display (LCD), one or more status indicator (e.g., one or more light-emitting diode (LED) or other status indicator), or other device configured to display information visually to the user. In other examples, the user-interface 105 can include a speaker to communicate information audibly to the user. In certain examples, the media presentation can include a multimedia presentation having both audio and video.

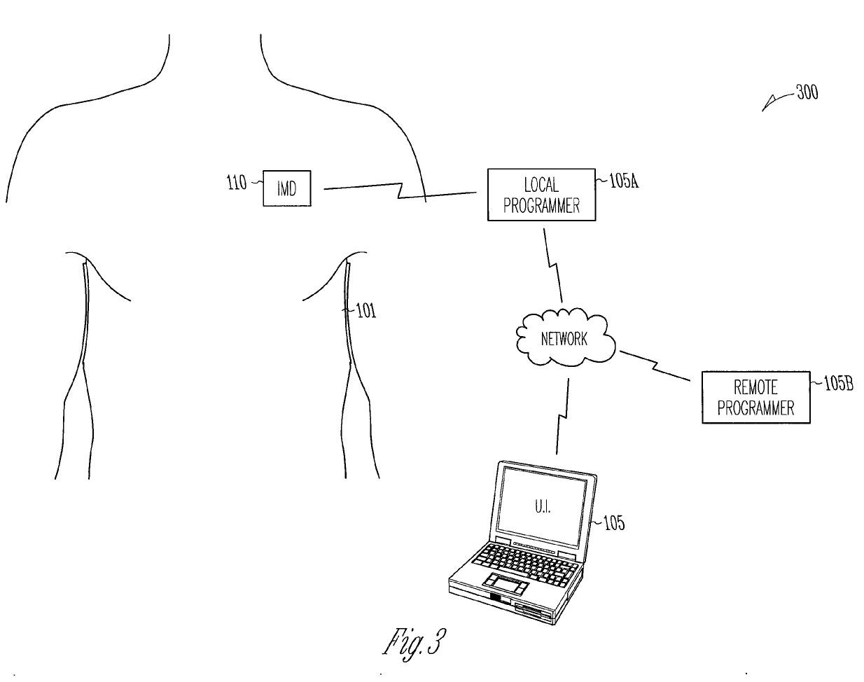

FIG. 2 illustrates generally an example of a system 200 including a user-interface 105 and an implantable medical device (IMD) 110. The implantable medical device 110 can be implanted in a patient 101 and can include a device configured to detect physiological information (e.g., heart rhythm or other physiological information) or to deliver therapy (e.g., pacing therapy, etc.), such as a pacemaker, a defibrillator, or other implantable medical device. In an example, the user-interface 105 can be communicatively coupled to the implantable medical device 110, such as wirelessly coupled to the implantable medical device 110 using a telemetry or other communication circuit, and can be configured to receive information from the implantable medical device 110 (e.g., implantable medical device or patient status information) or provide information to the implantable medical device 110 (e.g., programming or control instructions). In an example, the user-interface 105 can be configured to receive information from a user (e.g., programming or control instructions to be communicated to the implantable medical device 110 or other information), or to display information to the user (e.g., implantable medical device or patient status information, or other information configured to be displayed to the user) using the display 106.

In an example, the user-interface can be configured to determine the information to display to the user using information from the implantable medical device 110, information about a patient, or information from the user.

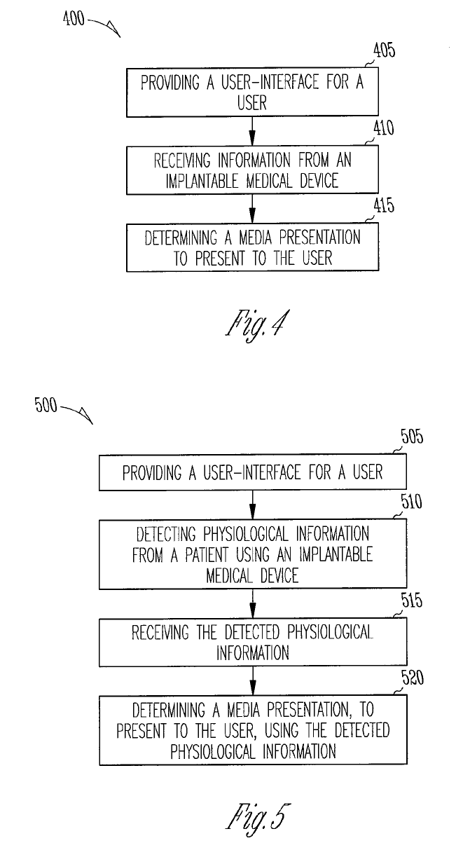

FIG. 3 illustrates generally an example of a system 300 including a user-interface 105, an implantable medical device 110, a local programmer 105a, and a remote programmer 105b.

In the example of FIG. 3, the implantable medical device 110 is communicatively coupled to the local programmer 105a, and the local programmer 105a is communicatively coupled to a network, the user-interface 105, and the remote programmer 105b. In an example, the local programmer 105a can include a repeater, a patient-operated medical device programmer, or other device configured to communicate locally with the implantable medical device 110 (e.g., via inductive telemetry). In an example, the local programmer 105a can be configured to receive information from the implantable medical device 110 and send information remotely (e.g., using a network, radio frequency communication, or other long-range communication) to another device, such as the user-interface 105 or the remote programmer 105b. In certain examples, the user-interface 105 can include a patient's home computer or other patient-operated user-interface, or the user-interface 105 can include the remote programmer 105b, or other physician-operated user-interface.

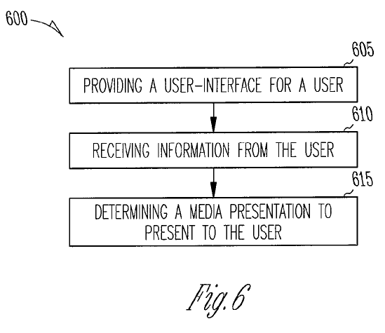

FIG. 4 illustrates generally an example of a method 400 including providing a user-interface to a user, receiving information from an implantable medical device, and determining a media presentation to present to the user.

At 405, a user-interface is provided to a user. The user-interface can include a medical device programmer, a computer, or other device configured to provide information to or receive information from the user (e.g., the user-interface 105). In an example, the user-interface can be configured to be communicatively coupled to an implantable medical device, the implantable medical device configured to be implanted in a patient. In certain examples, the user can include the patient (e.g., the patient 101), an electrophysiologist, a cardiologist, a physician, a nurse, or other person to receive information from or about the medical device.

At 410, information from an implantable medical device is received at the user-interface. In an example, the information from the implantable medical device can include information about the implantable medical device, such as the implantable medical device type, family, brand or manufacturer, a feature of the implantable medical device (e.g., an activated or a non-activated feature), a setting of the implantable medical device, or other parameter or other information about the implantable medical device. In other examples, the information from the implantable medical device can include information about the patient (e.g., information detected from the implantable medical device, etc.).

At 415, a media presentation to present to the user is determined. In an example, the media presentation can be determined at the user-interface. Generally, the media presentation can include an audio presentation, a text presentation, a still image presentation, an interactive presentation, an animated presentation, or a multimedia presentation (e.g., a video presentation or a combination of multiple media presentations). In an example, the determining the media presentation can include selecting one or more media presentation to present to the user from a plurality of available media presentations.

In certain examples, a media presentation can be stored on the user-interface, or the media presentation can be stored in a central location and transferred to the user-interface to present to the user. In certain examples, the media presentation can be created for a target audience (e.g., a patient, a physician, etc) or for a target topic (e.g., a target physiological condition, implantable medical device type, implantable medical device setting, implantable medical device feature, etc.). Further, the media presentation can be stored with a description of the information contained within. Thus, once the media presentation to present to the user is determined, the user-interface can provide the media presentation to the user using the stored description. In an example, once determined, the media presentation can be presented to the user using a display or a speaker located on the user-interface.

In an example, the media presentation can be determined using information about the user-interface. In certain examples, the information about the user-interface can include the type of user-interface. Generally, specific types of user-interfaces are operated by specific classes of users (e.g., patient-operated user-interfaces are generally operated by patients, physician-operated user-interfaces are generally operated by physicians, etc.). For example, if the user-interface includes a patient-operated user-interface (e.g., a patient-operated medical device programmer or a patient's home or portable computer, PDA, mobile phone, or other user-interface), then the media presentation can include information directed towards or otherwise created for the patient, or generally a person without training in the medial field. In other examples, if the user-interface includes a physician-operated user-interface (e.g., a physician-operated medical device programmer, a remote programmer, or a physician or other medical professional's computer, PDA, mobile phone, or other user-interface), then the media presentation can include information directed towards or otherwise created for the physician, or generally a person with training in the medical field. In yet other examples, if the user-interface includes a user-interface commonly operated by specific type or class of user (e.g., a electrophysiologist, a cardiologist, a nurse, or other medical professional), then the media presentation can include information directed towards or otherwise created for the specific type of user. In other examples, the information about the user-interface can include other information, such as user-interface status information, etc.

In an example, the media presentation can be determined using information received from the implantable medical device. In certain examples, the media presentation can be determined according to the received information, or the information received from the implantable medical device can include information about the implantable medical device. For example, if the received information includes an implantable medical device type (e.g., a pacemaker, a defibrillator, etc.), then the media presentation can include information about the implantable medical device type. If the received information includes information about a feature of the implantable medical device (e.g., an activated feature), then the media presentation can include information about that feature (e.g., a video including information about the feature). In an example, if the received information includes information about an activated feature, then the media presentation can be determined such that it does not include information about a non-activated feature of the implantable medical device. In other examples, the media presentation can be determined according to other received information about the implantable medical device.

In an example, the media presentation can be determined without requiring the user to directly determine the media presentation. For example, the user-interface can determine the media presentation to present to the user by inferring, using received information (e.g., received information from the user, from the user-interface, from the implantable medical device, or from some other source of information), the appropriate information to display to the user. In an example, the user-interface can determine one or more media presentations to present to the user, such as by displaying information about the one or more determined media presentation on a display. In this example, the user can select one or more of the one or more determined media presentation to view. In this example, although the user is selecting a media presentation to view, the one or more media presentation available to select was determined by the user-interface. In an example, the user-interface can select a number of media presentations from a plurality of available media presentations to display to the user, so long as the number of media presentations is less than the plurality of available media presentations. In other examples, the user-interface can select the plurality of available media presentations. In an example, the user cannot select a media presentation that has not been determined at the user-interface to be presented to the user.

FIG. 5 illustrates generally an example of a method 500 including providing a user-interface to a user, detecting physiological information from a patient, receiving the detected physiological information, and determining a media presentation to present to the user.

At 505, a user-interface is provided to a user. The user-interface can include a medical device programmer, a computer, or other device configured to provide information to or receive information from the user (e.g., the user-interface 105). In this example, the user-interface is communicatively coupled to an implantable medical device, the implantable medical device implanted in a patient.

At 510, physiological information from a patient is detected using the implantable medical device. The physiological information can include heart rhythm information (e.g., an electrocardiograph, heart sounds, etc.) or other physiological information of the patient that can be detected using an implantable medical device. In certain examples, the physiological information can be detected in response to a user inquiry, or the physiological information can be continuously detected or monitored, detected or monitored at regular intervals, or detected or monitored in response to a physiological or other trigger (e.g., an increase in patient heart rate, detected impedance between one or more electrode, etc.).

At 515, the detected physiological information is received. In an example, the detected physiological information can be received (e.g., wirelessly) at the user-interface.

At 520, a media presentation to present to the user is determined using the detected physiological information. For example, if the detected physiological information is indicative of a change in the status of the patient or patient condition, then the media presentation can be determined including information about the detected physiological information, information about the status of the patient, information about the patient condition, or information about the change in the detected physiological information.

FIG. 6 illustrates generally an example of a method 600 including providing a user-interface to a user, receiving information from the user, and determining a media presentation to present to the user.

At 605, a user-interface is provided for a user. The user-interface can include a medical device programmer, a computer, or other device configured to provide information to or receive information from the user (e.g., the user-interface 105). In an example, the user-interface can be configured to be communicatively coupled to an implantable medical device. In other examples, the user-interface can be configured to be communicatively coupled to an implantable medical device, although not actively communicatively coupled. In this example, the user-interface can be configured to determine a media presentation to present to a user using information received from the user, without being communicatively coupled to the implantable medical device.

At 610, information is received from the user. In an example, the user can input information to the user-interface. In an examples, the received information can include information about an implantable medical device, such as an implantable medical device type, family, feature, setting, or other parameter of the implantable medical device. In other examples, the received information can include information about the user, such as a user class (e.g., a patient class, an electrophysiologist class, a cardiologist class, a physician class, a nurse class, etc.), or the received information can include information about a patient, such as a patient history, a physiological condition, etc.

At 615, a media presentation to present to the user is determined. In an example, the media presentation can be determined using the information received from the user. For example, if the information received from the user includes a user class, then the media presentation can be determined including information directed to or otherwise created for the user class. If the information received from the user includes information about a physiological condition, then the media presentation can be determined including information about the physiological condition, or information about a medical device capable of monitoring or treating the physiological condition. If the information received from the user includes information about the implantable medical device, then the media presentation can be determined including information about the implantable medical device. In certain examples, the media presentation including information about the implantable medical device can include educational information (e.g., training information, general information, etc.), advertising information (e.g., information about an implantable medical device family, brand, type, model, etc.), or other information.

### OTHER EXAMPLES

In an example, an implantable medical device can be implanted in a patient. The implantable medical device can be communicatively coupled to a repeater positioned in the patient's home. The repeater can send information to a remote database or other device accessible, for example, through a network. In an example, the remote database or other device can receive or access the information from the implantable medical device. Further, the remote database or other device can, using the received or accessed information, determine what implantable medical device the patient has implanted, determine what features are activated on the implantable medical device, or determine an indication of the patient's condition. Then, the remote database or other device can determine one or more media presentations to present to the patient using the received information.

In an example, the user-interface can include a patient's home computer or other similar device. In an example, the patient can log on to a website using their home computer or other device capable of accessing the internet and view one or more media presentation including information about their implantable medical device, their physiological condition, or other information.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B.” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a user-interface configured to be communicatively coupled to an implantable medical device, the user-interface configured to determine a multimedia presentation to present to a user;
wherein the user-interface is configured to determine the multimedia presentation by selecting at least one multimedia presentation from a plurality of stored multimedia presentations using at least one of information received from the implantable medical device or information received from the user;
wherein the user-interface is configured to determine the multimedia presentation without requiring the user to directly determine the multimedia presentation.

2. The system of claim 1, wherein the user-interface is configured to determine the multimedia presentation to present to at least one of a patient, an electrophysiologist, a cardiologist, a physician, or a nurse.

3. The system of claim 1, the user-interface including a display, wherein the user-interface is configured to present the selected at least one multimedia presentation to the user to select to view using the display.

4. The system of claim 1, wherein the user-interface is configured to determine the multimedia presentation to present to the user using information received from the implantable medical device.

5. The system of claim 4, wherein user-interface is configured to determine the multimedia presentation using information received about the implantable medical device.

6. The system of claim 5, wherein the user-interface is configured to receive information about an activated feature of the implantable medical device for a patient, to determine the multimedia presentation using the information about the activated feature, and to present the multimedia presentation to that patient, the multimedia presentation including information about the activated feature.

7. The system of claim 4, wherein the user-interface is configured to determine the multimedia presentation using information received about a patient.

8. The system of claim 7, wherein the user-interface is configured to receive patient information, to determine the multimedia presentation using the patient information, and to present the multimedia presentation to that patient including information about the patient information.

9. The system of claim 1, wherein the user-interface is configured to determine the multimedia presentation to present to the user using information received from the user.

10. The system of claim 9, wherein the user-interface is configured to determine the multimedia presentation using information about a user class, the user class including at least one of a patient class, an electrophysiologist class, a cardiologist class, a physician class, or a nurse class.

11. The system of claim 9, wherein the user-interface is configured to determine the multimedia presentation using information about the implantable medical device, the information about the implantable medical device including information about at least one of an implantable medical device type or an implantable medical device family.

12. The system of claim 9, wherein the user-interface is configured to determine the multimedia presentation using information about a patient, the information about the patient including information about at least one of a physiological condition or a patient history.

13. A method comprising:
providing a user-interface for a user, the user-interface configured to be communicatively coupled to an implantable medical device;
receiving, at the user-interface, at least one of information from the implantable medical device or information from the user; and
determining, at the user-interface, a multimedia presentation to present to the user by selecting at least one multimedia presentation from a plurality of stored multimedia presentations using the received information, the determining without requiring the user to directly determine the multimedia presentation.

14. The method of claim 13, including presenting the selected at least one multimedia presentation to the user to select to view.

15. The method of claim 13, including:
receiving, at the user-interface, information from the implantable medical device;
wherein the determining the multimedia presentation to present to the user includes using the implantable medical device information.

16. The method of claim 15, wherein the receiving the information from the implantable medical device includes receiving information about an activated feature of the implantable medical in a patient, and wherein the determining the multimedia presentation includes using the activated feature information.

17. The method of claim 15, including:
detecting physiological information from a patient using the implantable medical device;
wherein the receiving the information from the implantable medical device includes receiving the detected physiological information, and wherein the determining the multimedia presentation includes using the detected physiological information.

18. The method of claim 13, including:
receiving information from the user;
wherein the determining the multimedia presentation to present to the user includes using the user information.

19. The method of claim 18, wherein the receiving the information from the user includes receiving at least one of a user class, information about the implantable medical device, or information about a patient.

20. A system comprising:
a user-interface, communicatively coupled to an implantable medical device, the user-interface configured to receive information about an activated feature of the implantable medical device for a patient, to select at least one multimedia presentation to present to the patient from a plurality of available multimedia presentations using the information about the activated feature, and to present the at least one selected multimedia presentation to the patient;
wherein the at least one selected multimedia presentation includes information about the activated feature without requiring information about a non-activated feature, and wherein the user-interface is configured to determine the multimedia presentation without requiring the user to directly determine the multimedia presentation.
